(19) United States
(12) Patent Application Publication
(10) Pub. No.: US 2013/0129966 A1
(43) Pub. Date: May 23, 2013

(54) Wind-Proof Table Linens

(71) Applicant: Lauren Fallon, Hancock, NH (US)

(72) Inventor: Lauren Fallon, Hancock, NH (US)

(21) Appl. No.: 13/298,716

(22) Filed: Nov. 17, 2011

(51) Int. Cl. A47G 11/00; B32B 3/04; B32B 3/02; B32B 3/06; B23P 11/00; B23P 17/04

(52) U.S. Cl. 428/99; 29/428; 29/525.08; 29/432; 428/192; 428/124

(57) ABSTRACT

The invention discloses a method and system for applying weight to a table linen to make it less susceptible of blowing in windy environments. In one embodiment, a bead chain is placed within one or more hems on the perimeter of the linen.

### TECHNICAL FIELD

This invention relates to table settings, and more particularly to textiles used while dining such as tablecloths and napkins.

### BACKGROUND

It is a known pleasure to dine alfresco, to enjoy a picnic in the country, to enjoy a meal sitting in the cockpit of a sailboat in a brisk wind, or to enjoy a tailgate meal at a football game. All of these pleasures are enhanced by the elegance of serving a meal with cloth table linens instead of paper. (When used herein, the term “table linen” refers to tablecloths and napkins and the like made from any cloth made from any textile fiber such as cotton, synthetic fiber combinations, or indeed, actual linen.)

It is frequently annoying in these settings to have one's napkin blown away by the wind. Indeed, it is well known in the art to employ a spring clips to hold a tablecloth to a picnic table to keep the tablecloth from lifting in the wind.

But what of napkins and other small linens? In use, they are susceptible of blowing about the table, off one's lap, overboard, or otherwise being lifted by the wind and taken away. Even tucking the napkin into one's shirt does not eliminate the problem: the wind still can blow the napkin about and be quite annoying.

What is needed is a way to prevent napkins and similar small table linens from being blown about by the wind while still being accessible and usable as they were designed.

### SUMMARY

The present invention solves the problem of cloth napkins and other small table linens from blowing about by applying one or more weights to the napkin in a manner which is unobtrusive and allows the napkin to continue to be used in the manner intended without unnecessary interference.

In one embodiment, a weight is attached to a clip such as a mitten clip, and the clip attached to the napkin. More than one clip may be beneficially utilized, depending upon the strength of the wind. The added weight applied to the napkin lessens its susceptibility being blown about by the wind. In another embodiment, a weighted bar, such as a piece of metal, having one or more pins on the bar, and inserting the pins through the fabric of the napkin and holding the ins in place by butterfly clips. The weighted bar may additionally be coated in a decorative material such as electroplating or plastic coating, and given a decorative design.

Both the foregoing embodiments suffer from having the weight possibly interfere with the intended use of the napkin. Rubbing one's face with a napkin only to find a mitten clip can be unsettling.

A preferred embodiment is to insert one or more weights held within an outer perimeter hem of the napkin. A preferred embodiment is to utilize bead chain as the weight, as it is flexible and thin enough not to interfere with the ordinary intended use of the napkin but heavy enough in long enough pieces to provide necessary weight. Placing the bead chain within an edge hem facilitates being able to iron the napkin. While any bead chain may be used, it has been found that bead chain made from stainless steel is preferable. Other metals may oxidize and discolor the napkin as a result of washing or long-term use.

### DESCRIPTION OF DRAWINGS

FIG. 1 is a drawing of a mitten clip with attached weight.

FIG. 2 shows a bar weight and butterfly clips.

FIG. 3 shows a napkin with bead chain captured inside two edge hems.

### DETAILED DESCRIPTION

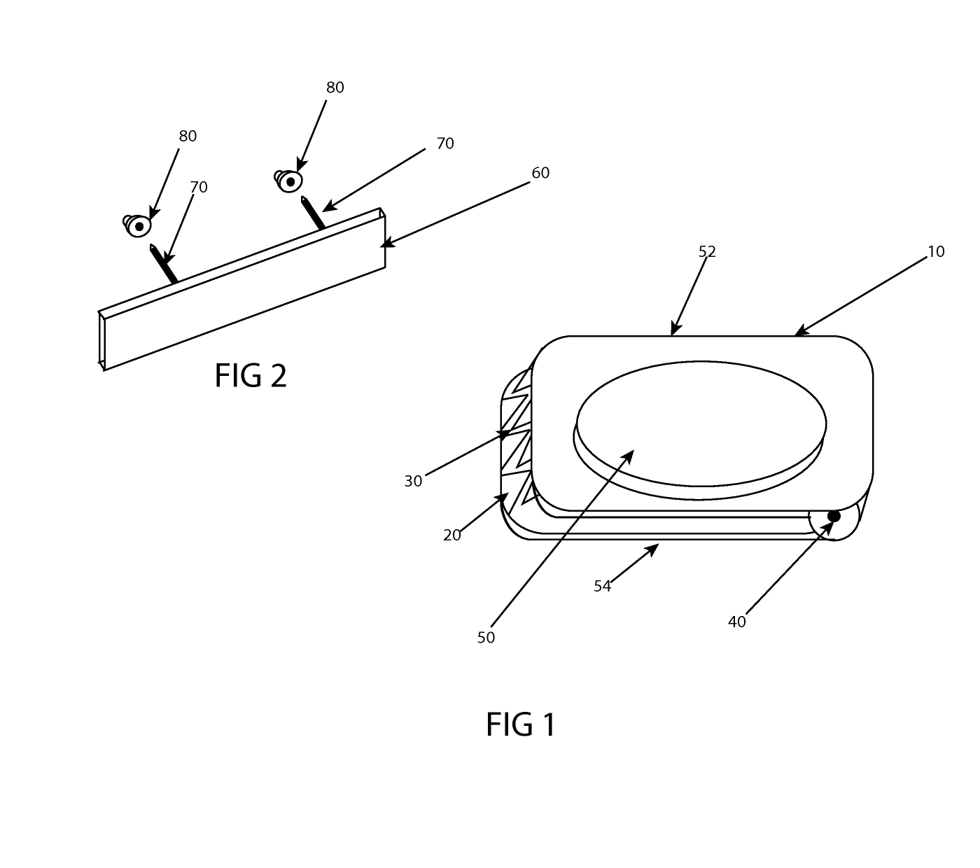

Referring to FIG. 1, one embodiment of the present invention is shown as a mitten clip 10 with an attached weight 50. The mitten clip has upper teeth 30 and lower teeth 20 and a hinge 40. The mitten clip 10 has an upper portion 52 and a lower portion 50 which are joined by the hinge 40. In use, the mitten clip 10 is opened by moving the lower half 54 away from the upper half 52 rotating about the hinge 40. A napkin is inserted between the upper portion 52 and lower portion 54 and the mitten clip closed. The teeth 20 and 30 hold a mitten clip in place and the weight 50 lessens the napkin's susceptibility to being blown by the wind.

The weight may be made of any convenient material and attached to the mitten clip by glue are other means well known in the art. It is preferable to choose a non-oxidizing material for the weight, and a material that is attractive. A metallic weight that has a decorative coating such as plastic, electroplating or paint is preferable. Decorative patterns may be applied to the weight as well.

Another embodiment of the present invention is shown in FIG. 2. A weight 60 is shown having two pins 70. In use, the pins 70 are inserted into the table linen (not shown) and held in place be inserting the pins 70 into butterfly clips 80. One or any number of pins may be utilized depending upon the size of the weight. The pins 70 should be of a length so as to be able to penetrate the napkin and be held by a butterfly clip 80 or similar device well known in the art. As before, it is preferable to use a weight made of a non-oxidizing material and one that is attractive. The weight may be coated with paint or plastic and a decorative pattern or logo may be applied as well.

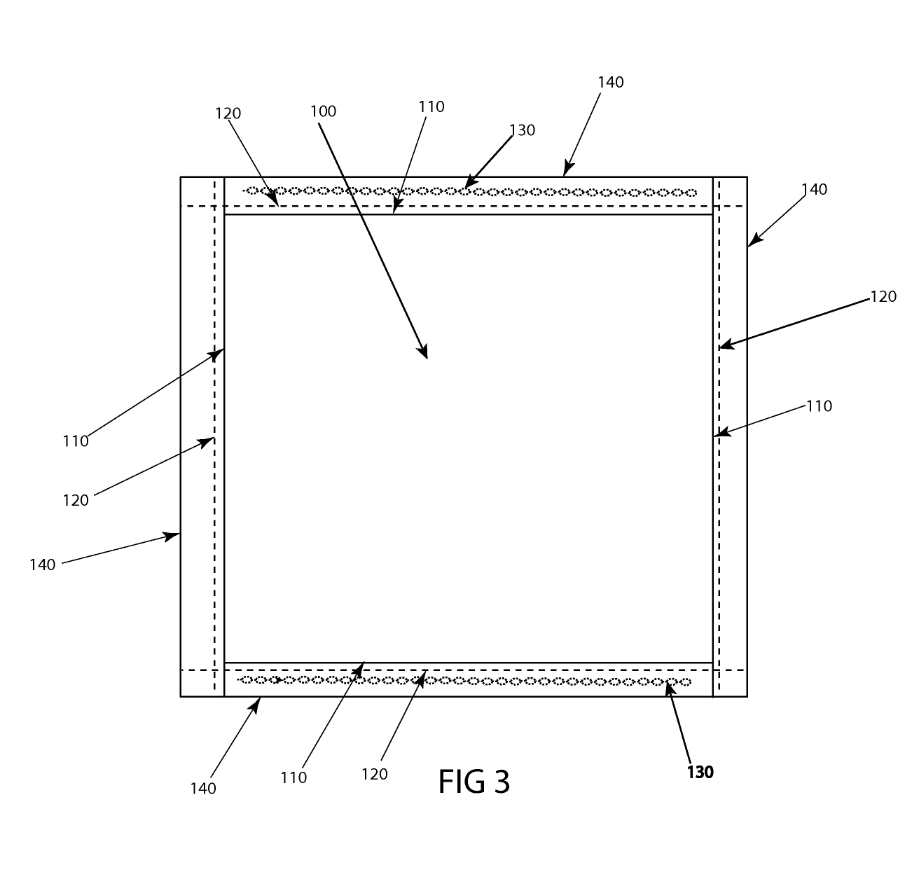

FIG. 3 shows a square napkin 100. The napkin has folded edges 110 held in place by seams 120 thus creating a hem 140 along each side of the napkin 100. Captured within two of the hems 140 is a length of bead chain 130. The bead chain 130 may be of any convenient length, but should be long enough to be of sufficient weight to accomplish the purpose of preventing the napkin from being susceptible of being carried away by the wind. Different combinations of size, length and material may be utilized beneficially. The larger the bead, the more difficult and obtrusive in use it becomes. Smaller beads have less weight and so longer lengths need to be utilized to achieve a desired weight. There is no one best solution of bead size and length.

A number of embodiments of the invention have been described. Nevertheless, it will be understood that various modifications may be made without departing from the spirit and scope of the invention. For example, mitten clip weights may be used in combination with napkins edged with bead chain in higher wind situations. The invention need not only be used with napkins; it may beneficially be used with tablecloths, runners, placemats and doilies. The table linen need not e rectangular; indeed, it may be of any shape and still benefit from the present invention. Accordingly, other embodiments are within the scope of the following claims.

I claim:

1. A wind resistant table linen comprising:
A table linen having at least on edge;
A weight, said weight being attached to said edge.

2. The wind resistant table linen of claim 1 wherein the said weight further comprises a mitten clip said mitten lip having a top; and further said weight being fixedly attached to said mitten clip top; said mitten clip being operable to be removably attached to said table linen edge.

3. The wind resistant table linen of claim one wherein said weight comprises a bar, said bar having at least one pin extending therefrom of a length suitable for piercing said table linen and extending a length, further comprising at least one butterfly clip sized to fir said at least one pin, said at least one butterfly clip operable to receive said at least one pin through said table linen thereby securing said weight removably to said table linen.

4. The wind resistant table linen of claim one wherein said at least one edge is folded over for a least a portion of said edge to form a hem; further comprising a bead chain having a length less than the said hem; said hem being sufficient in width to enclose said bead chain parallel to and within said hem; wherein said hem is secured so as to contain said bead chain.

5. The wind resistant table linen of claim 5 wherein said bead chain is made from stainless steel.

6. The wind resistant table linen of claim 4 wherein the said hem is secured by stitching.

7. The wind resistant table linen further comprising a perimeter; wherein the said perimeter comprises a bead chain containing hem.

8. A method of makiing a table linen wind resistant, comprising:
providing a table linen;
attaching a weight to said table linen.

9. The method of claim 8 further comprising providing a mitten clip; further comprising the step of fixedly attaching said weight to said mitten clip; further comprising the step of clipping said weighted mitten clip to said table linen.

10. The method of claim 8 wherein said weight is a bar; further providing at least one butterfly clip; further providing said weight with at least one pin attached to an extending from said bar; further comprising the steps of placing said bar against said table linen and pressing so as to have said pin pierce said table linen and securing said pin with said butterfly clip.

11. The method of claim 8 wherein said table linen comprises at least one edge and said weight further comprises a bead chain, further comprising the steps of:
folding over at least a portion of said at least one edge to form at least one hem, said at least one hem having a length;
cutting said bead chain to a length less than said hem length;
placing said bead chain along and within the said at least one hem ;
securing said hem in place.

12. The method of claim 11 wherein said bead chain is stainless steel.

13. The method of claim 11 wherein said ham is secured with stitching.

14. The method of claim 11 wherein said hem is secured by glue.
